(19) United States
(12) Patent Application Publication
(10) Pub. No.: US 2025/0237784 A1
(43) Pub. Date: Jul. 24, 2025

(54) Weather Prediction Neural Network Using Sensor Data Over Time

(71) Applicant: Michael V. Recker, Gaithersburg, MD (US)

(72) Inventor: Michael V. Recker, Gaithersburg, MD (US)

(21) Appl. No.: 19/024,136

(22) Filed: Jan. 16, 2025

Related U.S. Application Data
(60) Provisional application No. 63/622,715, filed on Jan. 19, 2024.

(51) Int. Cl. G01W 1/10; G01W 1/02; G06N 3/04; G08B 21/10; G08B 31/00

(52) U.S. Cl. CPC G01W 1/10; G01W 1/02; G06N 3/04; G08B 21/10; G08B 31/00

(57) ABSTRACT

Describe herein are methods for weather prediction comprising receiving sensor data generated by a sensor system measuring weather related data that characterizes an environment in a vicinity of the sensor system as of a current time point, wherein the sensor data comprises a plurality of sensor samples characterizing the environment that were each captured at different time points, processing a sensor input comprising the sensor data using a neural network to generate a weather prediction output for a region of the environment, wherein the weather prediction output characterizes, for one or more future intervals of time after the current time point, a respective likelihood that the region of the environment will be affected by a change in weather in the environment during the future interval of time and providing a weather prediction of a future weather condition based on the weather prediction output.

### CROSS REFERENCE TO RELATED APPLICATION

This application claims the benefit of priority of U.S. Provisional Application No. 63/622,715, filed Jan. 19, 2024. The foregoing application is incorporated herein by reference in entirety.

### FIELD

The present disclosure relates generally to weather prediction.

### BACKGROUND

Weather prediction has long relied on numerical weather models that use vast amounts of atmospheric data, processed through physics-based simulations, to forecast future conditions. These traditional methods often require significant computational resources and time to produce results, limiting their real-time applicability, especially for localized and rapidly evolving weather patterns. Recent advancements in machine learning and neural networks have provided an opportunity to revolutionize weather forecasting by enabling models to learn complex patterns and relationships in atmospheric data, offering faster and potentially more accurate predictions.

Neural networks, particularly deep learning architectures, have shown promise in processing large datasets collected from remote weather sensors such as satellites, radars, ground stations and environmental sensors. By training these neural networks on historical weather data and corresponding future outcomes, a weather prediction system can develop the ability to predict conditions like precipitation, temperature, and wind speed with higher precision. Such approaches leverage spatial and temporal correlations in the data, allowing predictions to adapt dynamically to changing conditions. This disclosure describes apparatuses and methods for employing a trained neural network to interpret data from remote sensors and deliver real-time, localized weather forecasts, offering a transformative approach to meteorological prediction.

### SUMMARY

The presently disclosed embodiments may include a method implemented by one or more data processing apparatus, the method comprising receiving sensor data generated by a sensor system measuring weather related data that characterizes an environment in a vicinity of the sensor system as of a current time point, wherein the sensor data comprises a plurality of sensor samples characterizing the environment that were each captured at different time points, processing a sensor input comprising the sensor data using a neural network to generate a weather prediction output for a region of the environment, wherein the weather prediction output characterizes, for one or more future intervals of time after the current time point, a respective likelihood that the region of the environment will be affected by a change in weather in the environment during the future interval of time and providing a weather prediction of a future weather condition based on the weather prediction output.

Consistent with other disclosed embodiments, non-transitory computer readable storage media may store program instructions, which are executed by at least one processor and perform any of the methods described herein.

The foregoing general description and the following detailed description are exemplary and explanatory only and are not restrictive of the claims.

### BRIEF DESCRIPTION OF DRAWING(S)

The accompanying drawings, which are incorporated in and constitute a part of this disclosure, illustrate various disclosed embodiments. In the drawings:

FIG. 1 is a schematic diagram of an illustrative embodiment of a distributed weather sensor network using artificial intelligence (Al) implemented in a neural network to predict future weather conditions and events.

FIG. 2 shows an example set of sensors and components that may be used in one or more distributed weather sensors.

FIG. 3 is a block diagram representation of a weather sensor array being input to a neural network resulting in a representative output feature vector.

FIG. 4 is a diagram of a trained weather sensor neural network that receives arrays of weather sensor data and outputs representative feature vectors that point to one or more clusters of similar weather conditions and events.

FIG. 5 is a schematic diagram illustrating an example weather sensor array data structure over time.

FIG. 6 is a schematic diagram of an illustrative embodiment of a weather prediction neural network wherein the prediction may be based on input of a plurality of weather and environmental sensors.

FIG. 7 is a schematic diagram of an illustrative embodiment of a distributed weather sensor network using artificial intelligence (Al) implemented in a cloud server to predict future weather conditions and events.

FIG. 8 is a flowchart showing an exemplary process for implementing a weather prediction system using remote weather sensors.

FIG. 9 is a flowchart showing an exemplary process for implementing a weather prediction system using remote weather sensors and a cloud server.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of systems, apparatuses, and methods consistent with aspects related to the present disclosure as recited in the appended claim.

Weather prediction is a complex and challenging task due to a multitude of factors that contribute to the Earth's atmospheric dynamics. The atmosphere is a dynamic system with interconnected variables such as temperature, humidity, pressure, and wind patterns. The number of interacting elements makes it difficult to model accurately. Additionally, the Earth's surface is diverse, featuring oceans, mountains, deserts, and forests, each influencing local weather patterns differently.

The chaotic nature of the atmosphere further complicates predictions. Small variations in initial conditions can lead to significant differences in outcomes, a phenomenon known as the butterfly effect. Predicting how these subtle changes will propagate through the atmosphere over time requires sophisticated models and considerable computational power.

Furthermore, understanding of certain atmospheric processes, such as cloud formation and precipitation, remains incomplete. The lack of comprehensive data on these phenomena makes it challenging to develop precise predictive models. Technological advancements have improved the ability to collect data from satellites, weather stations, disparate environmental sensors and other sources, but the complexity of the atmosphere means that uncertainties persist.

To address these challenges, the described embodiments propose the use of weather and environmental sensors and artificial intelligence in the form of a neural network to refine the predictions, at the local level or at the larger geographical level. The proposed embodiments use the capture of weather sensor data over time input into a trained neural network to identify patterns of sensor data that have been detected in the past, wherein the patterns of sensor data over time may be correlated to weather conditions and events, such that when the weather sensor data is presented to the trained neural network the result may be a prediction of future weather patterns. The weather and environmental sensors may also be distributed over many locations where connectivity from devices at disparate locations communicating to centralized processing (e.g., a server) in the cloud may benefit the system by allowing refined training of the neural networks and improve weather predictions based on the collection of data over a large geographical area.

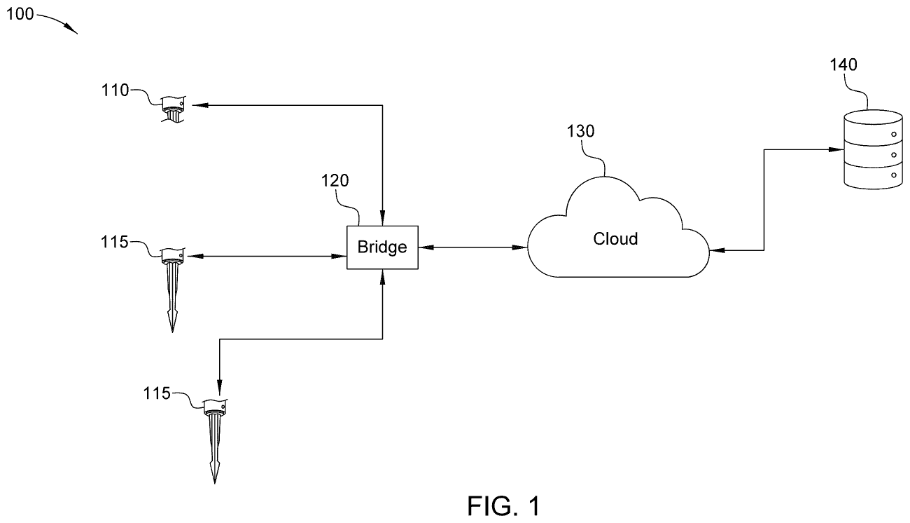

FIG. 1 shows an illustrative embodiment of a distributed weather sensor network 100 that may use artificial intelligence (Al) implemented in a neural network to predict future weather conditions and events. In the illustrated embodiment, the distributed weather sensor network 100 may include, but is not limited to, one or more wall weather sensor 110, ground weather sensor 115, bridge 120, cloud 130 and/or server 140. FIG. 1 shows an interface to cloud 130 where sensor data may be uploaded along with identified weather conditions and events to cloud 130 such that one or more processors (e.g., server 140) connected to cloud 130 may collect data to be used in weather prediction using a neural network implemented in server 140 or to be used in neural network training to allow the distribution of neural network information to one or more distributed weather sensor networks 100 in the field. It is to be appreciated that the neural network may be implemented in the bridge 120 or in the server 140. By way of the example architecture shown in the illustrative embodiment, one or more wall weather sensors 110 and/or ground weather sensors 115 may contain one or more sensors that may measure, detect or sense characteristics of the surrounding environment. For example, ground weather sensor 115 may contain a temperature sensor to measure ambient temperature, a barometer to measure atmospheric pressure, a hygrometer to measure humidity in the air or any other environmental sensor configured to monitor and measure different aspects of the atmosphere and surroundings. Further, wall weather sensor 110 and/or ground weather sensor 115 may contain a processing unit including at least one processor configured for collecting and processing sensor information, memory for storing data and an executable program and a network interface for communicating the information to an external processing device (e.g., bridge 120 or server 140) for further processing. In some embodiments, a variety of sensor data (e.g., information related to weather phenomena) may be collected over time and stored in an array of data samples over time. It is to be appreciated that the distributed weather sensor network 100 may include a plurality of weather sensors, such as wall weather sensor 110, ground weather sensor 115 or the like, that may range across many geographic locations. In embodiments, the wall weather sensor 110, ground weather sensor 115 or other similar environmental sensing devices may be an electronics design using sensor components designed into a housing made of plastic, metal or any other material from which an electronics housing may be constructed. The electronics and housing may be designed to allow the weather and environmental sensors to make accurate measurements of the surroundings. Further, power for the electronics may be included in the form of battery, solar panels, wired power or any other power type that may be appropriate for an outdoor sensor device.

For example, ground weather sensor 115 may be designed in a plastic housing with a ground stake that may allow it to be mounted in the yard of a homeowner. The ground weather sensor 115 may contain several sensor devices to collect data and a processing unit to process and/or communicate the data to a remote processing device. Further, ground weather sensor 115 may be battery powered allowing the device to be mounted in any location where the stake could be driven into the ground. Many homeowners may install ground weather sensors 115 creating a distributed network of weather sensors.

By way of an example, thousands of homes across the United States (or a region of the United States) may have a local group of weather sensors installed, each connected to or communicating with server 140 via cloud 130. Server 140 may contain training information for neural networks integrated into wall weather sensors 110, ground weather sensors 115 and/or bridges 120 throughout the many geographic locations and may be capable of distributing updated training information for neural networks based on information gathered from sensor or from known scenarios. The updated neural network training may be based on sensor information from weather sensors at disparate locations. Thus, patterns of sensor information collected at disparate locations that may correlate to weather conditions and events from across the United States or regions of the United States may be used to better predict future weather conditions and events throughout the distributed weather sensor network. In an alternate example, server 140 may contain training information for neural networks integrated into server 140 such that server 140 implements the neural network that provides a weather prediction output.

The result of training or retraining a neural network may be an optimized set of parameters (e.g., weights and biases) that allow the neural network within the weather sensor network 100 to make accurate predictions or classifications for weather prediction. During the training process, the neural network may learn (i.e., be trained to provide an accurate prediction) based on a labeled dataset by adjusting its parameters to minimize the difference between the neural network predictions and the actual target values. The labeled dataset may be a collection of data where each input example (e.g., set of sensor data) may be paired with a corresponding output label (e.g., historical weather condition resulting from the set of sensor data). These labels provide the “ground truth” that the network learns to make weather predictions during training. Labeled datasets are essential for supervised learning tasks, as they may guide the neural network in understanding the relationships between inputs and outputs to enable accurate weather prediction. Training using the labeled dataset may be done through an optimization algorithm, such as gradient descent. As the training progresses, the internal representations of the neural network may be refined and the neural network may learn to recognize patterns and relationships within the data. The success of training may often be evaluated on a separate validation dataset to ensure that the model generalizes well to new, unseen weather conditions and event examples. The final trained neural network may then be used for making predictions on new, unseen weather sensor or environmental sensor data. The effectiveness of the trained model depends on various factors, including the architecture of the neural network, the quality and quantity of the training data, and chosen parameters during training. It is to be appreciated that training may be a process to develop the programming of a neural network, including the weights and parameters of the neural network, for the weather prediction application. Once the programming is determined, the real time operation of the neural network may be based on the set of programming determined during training.

Distributed weather sensor network 100 may include an external processing device associated with weather sensors at a location (e.g., bridge 120). Bridge 120 may include, but is not limited to, a processor, memory, a power source, a first communication interface and a second communication interface. Via the first communication interface, bridge may communicate with wall weather sensors 110, ground weather sensors 115 and any other end device that may be used to gather information relevant to predicting weather conditions and events. Thus, in embodiments, bridge 120 may collect information from one or more wall weather sensors 110, ground weather sensors 115 or other sensor devices, process the information and may, via the second communication interface, communicate using cloud 130 interface to communicate with one or more remote processors (e.g., a server 140). Additionally, bridge 120 may communicate with local user devices such as a cell phone running an application or a personal computer running a program that may collect information and possibly alert a user based on a prediction of an upcoming weather condition or event based on the collected sensor information. In alternate embodiments, bridge 120 may be implemented by the local user device. In other embodiments, there may not be a bridge 120 in the system and the weather sensor devices may be connected to cloud 130 and may communicate via cloud 130 to one or more servers 140. In some embodiments, bridge 120 may be implemented in a smart home hub, wifi router, security system processor or other device that may be located at a location where it may be advantageous to include bridge 120 functionality.

Distributed weather sensor network 100 may include local area or wide area network connectivity and processing and storage infrastructure associated with weather sensors and bridges at one or more locations (e.g., cloud 130). Cloud 130 may refer to a distributed computing infrastructure that provides on-demand access to computing resources and services over the internet. This infrastructure may be composed of multiple interconnected servers, data storage, and networking components hosted in data centers. By way of an example, wireless sensors and bridges may be installed at the home of a consumer and connected to their home network (e.g., Ethernet, Wifi). The consumer may have an internet connection, for example a cable modem, fiber connection or wireless connection to an internet service provider. Server 140 may also have an internet connection and communicate over the network. It is to be appreciated that cloud 130 may provide interconnectivity to allow communication between the wireless sensors, bridge 120 and server 140. Furthermore, server 140 may be considered to be “in the cloud” and may provide processing and storage services to disparate weather sensors and bridge at many locations. Cloud 130 may include a multitude of servers 140, organized into within data centers. Each server 140 may be equipped with processing units, memory modules, and storage devices. Servers 140 may operate collaboratively to provide computational power for various workloads. Communication between weather sensors, bridges and server 140 via cloud 130 may involve a series of interactions and data exchanges to enable connectivity, data transfer, and control between end devices.

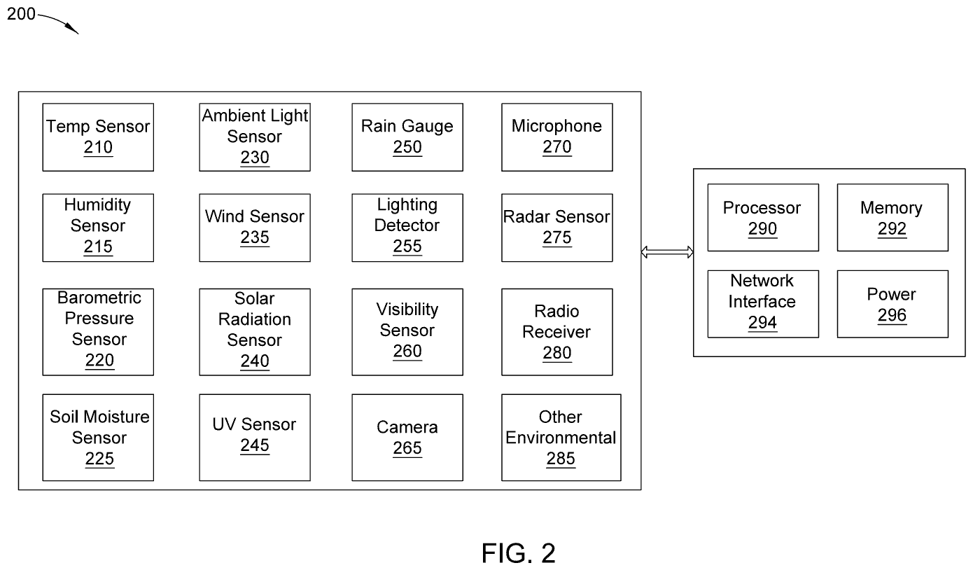

FIG. 2 shows an example of a weather sensor device 200 including a set of sensors, components and a processing unit that may be used in a distributed weather sensor (e.g., wall weather sensor 110, ground weather sensor 115 etc). It is to be appreciated that the sensors shown in FIG. 2 may be in one device or in a plurality of devices. In the example, the weather sensor device 200 may include, but is not limited to, one or more temperature sensor 210, humidity sensor 215, barometric pressure sensor 220, soil moisture sensor 225, ambient light sensor 230, wind sensor 235, solar radiation sensor 240, UV sensor 245, rain gauge 250, lighting detector 255, visibility sensor 260, camera 265, microphone 270, radar sensor 275, radio receiver 280 and any other environmental sensor 285 that may gather information about the surrounding environment that may be used in conjunction with the disclosed embodiments. Further, the weather sensor device 200 may include a processing unit that may include, but is not limited to, processor 290, memory 292, network interface 294 and power 296. Processor 290 may execute instructions in memory 292 and may be configured to collect data from the sensor devices for storage in memory 292 or communication via network interface 294. Further, the processing unit may communicate with a user (e.g., consumer), with a server 140 or with any other end device that may benefit from sensor information. The processor 290 may execute instructions in memory 292 to implement a neural network configured to receive input data from the sensors, detect patterns in the data and as a result, generate one or more predictions of future weather conditions or events. It is to be appreciated that one or more neural networks developed, trained and implemented in the weather sensor device 200, bridge 120, and/or server 140 may be used to identify sensor data patterns over time to allow for a prediction to be made for a future weather condition.

In some embodiments, the processing unit may be present in the weather sensor device 200 and may implement the neural network (e.g., in the wall weather sensor 110, ground weather sensor 115 etc.). In some embodiments, a processing unit that may implement the neural network may be present in bridge 120. In some embodiments the processing unit that may implement the neural network may be present in the server 140. The processing unit in the weather sensor device 200 may collect the data and communicate the data to a processing unit in bridge 120 and/or server 140 to create the sensor data array for input to the neural network. In alternate embodiments, the neural network may be implemented in server 140 and collected sensor data sampled over time may be communicated via cloud 130 to server 140 where one or more data processing apparatus may be configured to process the data to generate one or more predictions of future weather conditions or events. It is to be appreciated that the output of the neural network to generate one or more predictions of future weather conditions or events may be in the weather sensor device 200, bridge 120 or server 140 and the result or information pertaining to the future weather conditions or events may be communicated to a user (e.g., user device) in the form of an alert, message, text, email or other notification including the prediction of future weather conditions or events.

By way of an example, a temperature measurement, humidity measurement, barometric pressure measurement, capture of several pixels of the sky by the camera, capture of sound, wind speed and direction measurement, lumen measurement of ambient light and the like may be captured every 30 seconds (i.e., a sample rate of 30 seconds). The sensor data may be communicated to bridge 120. An array of sensor data captured over 2 hours may be input into a neural network located in bridge 120 wherein the array may comprise of 14,400 samples of measurements from the weather and environmental sensors. Bridge 120 may input the array of sensor data to a trained neural network. Changes in detected conditions may create a pattern by which a trained neural network may be able to make a prediction of future weather conditions or events. In alternate embodiments, the samples of sensor data may be input into a trained neural network in server 140 to make a prediction of future weather conditions or events.

Various indicators present in the array of sensor data may signal the possibility of a change in weather. For example, darkening or thickening clouds that may be detected by pixels of the sky captured by camera 265, such as if they have a greenish or dark gray tint, may indicate an approaching storm. The color changes may result from the scattering of sunlight by water droplets or ice crystals in the atmosphere. A sudden drop in temperature may be a precursor to a weather change. This may be detected as a noticeable decrease in the air temperature as may be detected by temperature sensor 210. An increase in wind speed that may be detected by wind sensor 235 may suggest an approaching weather front. A significant drop in barometric pressure as may be measured by barometric pressure sensor 220 (detecting changes in atmospheric pressure) may precede the arrival of a storm. A rise in humidity as may be detected by humidity sensor 215 may signal the potential for precipitation. High humidity levels may be associated with warm, moist air that may contribute to the development of storms. Measurements or changes in sensor measurements of ocean currents, tide levels or ocean water temperature may allow for a prediction of future weather conditions. The use of a neural network to recognize and interpret patterns present in the array of sensor data over time from several different types of weather sensors may allow for a combination of factors to contribute to improved prediction of future weather conditions or events in near real time. In another example, tornadoes are extremely dangerous and indicators from weather sensors on the scale of 5 second samples may allow an alert system for emergency notification based on weather sensor device 200 information and processing by a neural network to make residents aware based on signs that may indicate that a tornado is imminent. Sensor detection of lightning, heavy rain, rotating clouds, green tinted sky, sudden changes in wind pattern such as calm followed by intense winds, audible intense, low frequency sounds and/or rapidly falling barometric pressure may allow a neural network to make a faster prediction of an imminent tornado.

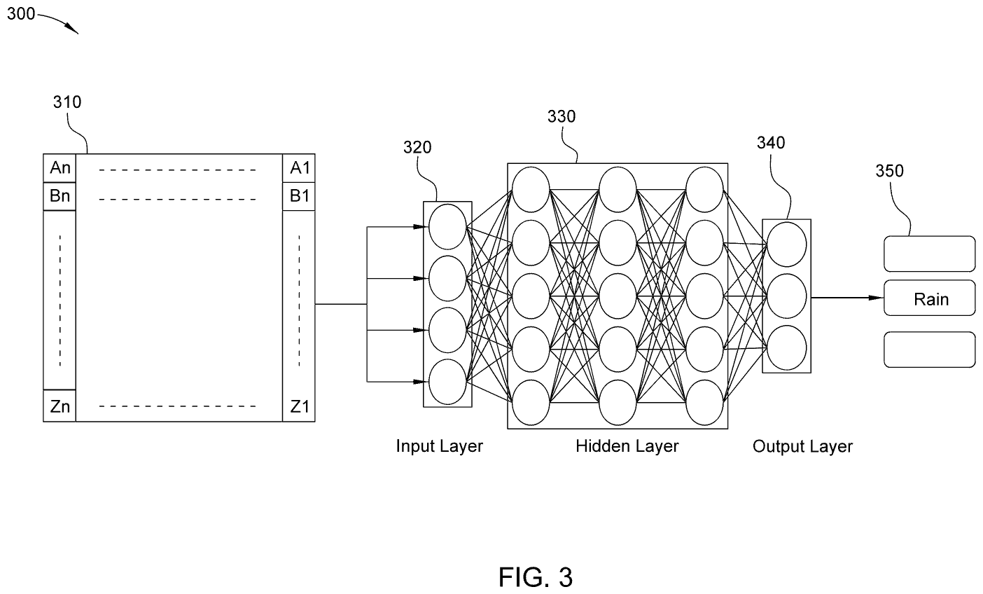

FIG. 3 is a block diagram representation of an example weather sensor array that may be input to a weather prediction neural network 300 configured to produce a representative output feature vector. In the example, the weather prediction neural network 300 may include, but is not limited to, one or more sensor array inputs 310, an artificial neural network (e.g., a convolutional neural network) comprising of input layer 320, hidden layers 330 and output layer 340 may be configured to produce an output feature vector indicative of a potential current or future weather event 350. In some embodiments, the layers of the neural network may consist of nodes (i.e. neurons) and interconnections of nodes.

By way of an example, the weather prediction neural network 300 may include a convolutional neural network. Input layer 320 may receive one or more sensor array inputs 310 including weather and environmental sensor data. The dimensions of the input layer may be determined by the size of the one or more sensor array inputs 310. Hidden layers 330 may include, but are not limited to, convolutional layers, pooling layers and fully connected layers. Output layer 340 may produce the final prediction or classification (e.g., may generate a vector to lookup a prediction of current or future weather event 350 based on training). It is to be appreciated that convolutional neural networks may be trained on labeled datasets, where sensor array inputs 310 may be associated with a corresponding target label. During training, the neural network may learn such that its parameters may be adjusted to minimize the difference between predicted and actual outputs, in this application to minimize the difference between weather predictions and actual weather outcome.

In embodiments, weather sensor data that may consist of time series information, such as sensor readings over time and neural networks, may be adapted for temporal processing based on time series information. In embodiments, a neural network may be applied to capture or identify patterns and dependencies in the temporal domain. In scenarios where weather sensor data may be received from multiple types of sensors (e.g., temperature, humidity etc), neural networks may be employed to identify patterns in the information and learn complex relationships between different sensor modalities (i.e., detect patterns in the weather sensor data between a plurality of sensors where the relationship may not be obvious but that nonetheless may allow prediction of future weather events). For example, temperature and pixels captured of the sky may not have an obvious connection however a neural network may detect a pattern in a relationship between the two sensor data inputs that allow for a more accurate prediction of future weather conditions to be made.

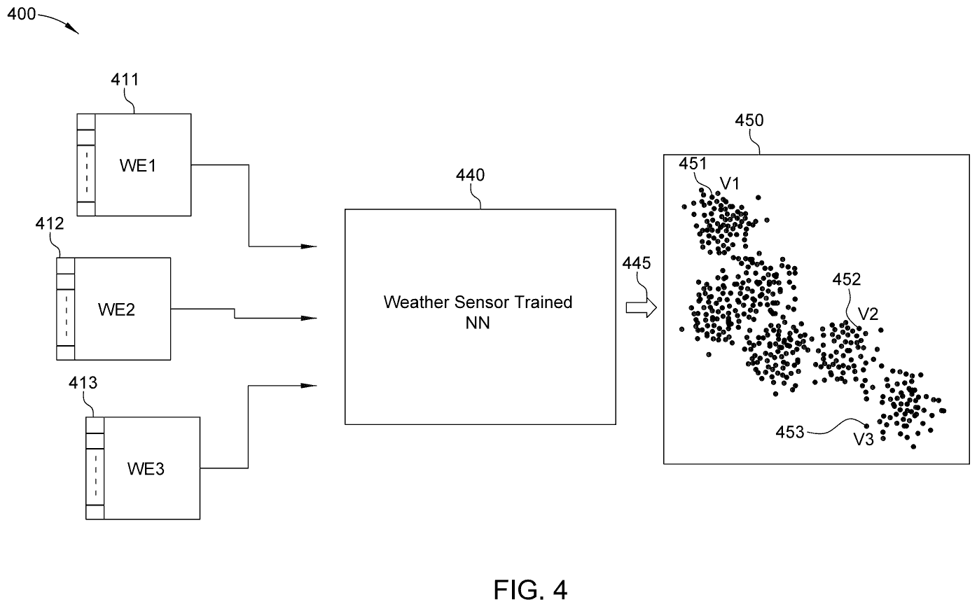

FIG. 4 is a diagram of a trained weather prediction neural network 400 wherein arrays of weather sensor data may be input into a weather sensor trained neural network and representative vectors may be generated that points in one or more clusters of similar weather conditions and events. In the example, the trained weather prediction neural network 400 may include, but is not limited to, one or more sensor array inputs 411 412 and 413, a trained neural network 440, a vector output 445, a feature space 450 including clusters and weather prediction points 451 452 and 453 associated respectively with vectors V1, V2 and V3. In the context of trained neural network 440, feature space 450 may include clusters that refer to groups or regions in the input space identified by one or more sensor array inputs where the neural network may tend to produce similar or consistent outputs. Feature space 450 and associated clusters within may represent patterns or features in the weather sensor data that the neural network has learned during the training process. Trained neural network 440 may be used for weather prediction tasks such as classification or clustering around likelihood of future weather conditions or events. Trained neural network 440 may map input data points to specific regions or clusters in feature space 450.

By way of an example, sensor array input 411 may be processed by trained neural network 440 where vector V1 may be produced. Vector V1 may allow for the identification of weather prediction point 451 in feature space 450. Included in the sensor information of sensor array input 411 may be an indication that a severe thunderstorm may be starting within a number of minutes. Based on the identified weather prediction point 451, an alert may be generated to seek shelter along with a time frame to expect the severe thunderstorm to start. In some examples, the vector may point to a part of the feature space that may not be associated with a prediction of a future weather event (e.g., an unrecognized weather event wherein training of the neural network did not result in the pattern of sensor array input to result in a prediction). In such a case, the result may be an exception that captures the sensor array input data, a determination of what may be a prediction of future weather conditions or events and stores the information for future training of the neural network to improve prediction accuracy.

In some cases, the information may be sent via cloud 130 to server 140 to capture the information for future training purposes. By way of an example, server 140 may receive generated feature vectors (e.g., vectors associated with the feature space) and weather condition information from distributed weather sensor devices, bridges and the like. Server 140 may receive a plurality of feature vectors and sensor array information from one or more disparate locations. Server 140 may identify weather event types associated with the received features vectors and sensor array information and may add points to the feature space. After a subsequent training of the neural network, server 140 may distribute updated neural network programming information including parameters and weights.

In some embodiments, points located within clusters in the feature space may allow a prediction of time to a weather event or degree of severity of a weather event. For example, a feature vector may point to the edge of a cluster in feature space. Over subsequent time samples, subsequent vectors may identify a point closer to the center of a cluster and the change in location in the cluster associated with the vector may identify differences in time or severity. For example, upcoming rain may initially be identified at the edge of a cluster typically associated with rain with a first feature vector. Based on the second feature vector, a change in position of the second feature vector as compared to the first feature vector may identify a rate of change of the rain (e.g., whether the rain will start sooner or later, changes in the amount of rain to be expected and the like). For example, the weather prediction may be “rain staring in 3 minutes” in one scenario as identified by a change in two feature vectors and the weather prediction may be “rain starting in 5 minutes” in a second scenario where the rate of change in the feature vectors indicates a slower change in weather conditions.

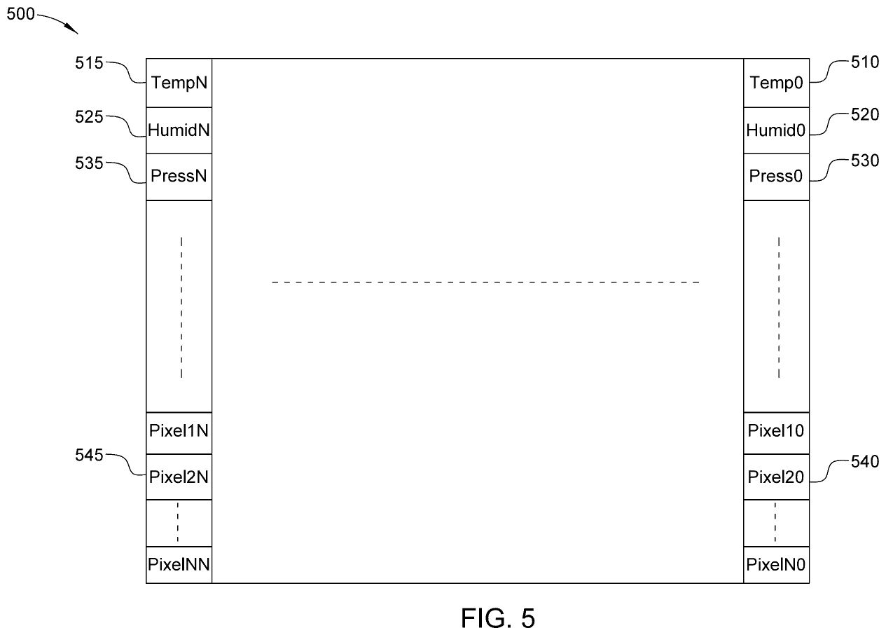

FIG. 5 is a schematic diagram illustrating an example weather sensor array data structure over time 500. In the example, the weather sensor array data structure over time 500 may include, but is not limited to, temperature data 510 and 515, humidity data 520 and 525, barometric pressure data 530 and 535 and pixel data 540 and 545. As shown in FIG. 5, the sensor data may be represented from time 0 through time N. It is to be appreciated that any number of samples or any sample rate may be used in conjunction with disclosed embodiments. It is to be appreciated that the weather sensor data in the array may have various representations of sensor data are Boolean, binary, featured values, continuous data, numeric values and any other form of information that the output of a sensor device that detects and responds to some type of input from the physical environment may be represented as.

By way of an example, temperature data 510 and 515 may be represented by two bytes of data representing a digital representation of a range of temperatures from minus 40 degrees C. to plus 70 degrees C. as may be captured and converted by the temperature sensor (e.g., analog to digital conversion of the analog temperature measured by the temperature sensor). In another example, pixel data 540 and 545 may be captured by a camera wherein the color of the pixel may be represented by three bytes including R, G and B information that make up the color. A camera pointed toward the sky may detect sky color through the capture of images or video (e.g., blue sky, color of clouds) and may convert the captured data to a format as required by the sensor array data.

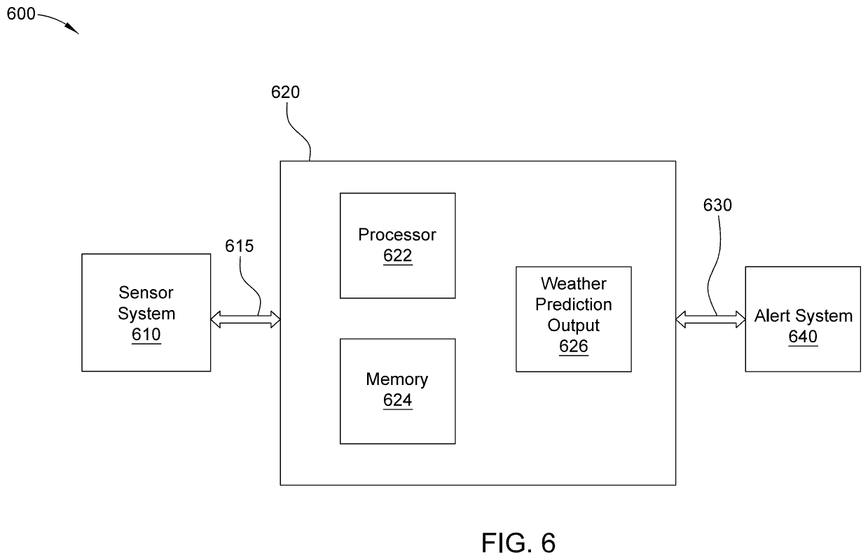

FIG. 6 is a schematic diagram of an illustrative embodiment of a weather prediction neural network 600 wherein the prediction may be based on input of a plurality of weather and environmental sensors. In the illustrative embodiment, the weather prediction neural network 600 may include, but is not limited to, sensor system 610, sensor data 615, processing unit 620 which may include processor 622, memory 624 and weather prediction output 626 that may implement a neural network, weather prediction output 630 and alert system 640. In the illustrated embodiment, a method may be implemented by one or more data processing apparatus. The method may comprise of receiving sensor data 615 generated by a sensor system 610 measuring weather related data that characterizes an environment in a vicinity of the sensor system 610 as of a current time point, wherein the sensor data 615 comprises a plurality of sensor samples characterizing the environment that were each captured at different time points. The sensor system 610 may contain sensors as described herein, for example as described previously in FIG. 1 and FIG. 2. Sensor data 615 may be input to processing unit 620 as a weather sensor data array.

Processor unit 620 may be configured for processing a sensor input comprising the sensor data 615 using a neural network to generate a weather prediction output 626 for a region of the environment, wherein the weather prediction output 626 characterizes, for one or more future intervals of time after the current time point, a respective likelihood that the region of the environment will be affected by a change in weather in the environment during the future interval of time. The weather prediction output 626 may be a vector generated to map to feature space represented weather conditions and events identified by a trained neural network in response to sensor data 615 related to weather and environmental sensor data. The weather prediction output 626 may point to a cluster within feature space that may allow a prediction of future weather conditions or events that the neural network may not have been previously trained on (i.e., the cluster identified in the feature space may allow for a prediction of future weather conditions and events even if the neural network training had not considered such a vector).

Processor unit 620 may be configured for providing a weather prediction based on the weather prediction output 626 to an alert system 640 to generate a notification of a future weather condition to a user. The notification may be in the form of a text alert, message, email, pop up notification, output of a dedicated device (e.g., a weather station), a banner on a television or a display, a voice announcement via a radio or Alexa device or any other notification method that may be used to capture user attention to the alert. Alert content may consist of the weather condition or event, severity, timing or any other information that may be relevant to a user. For example, the alert may include “rain expected to start in 10 minutes”, “rain will stop in 3 minutes”, “tornado warning seek shelter immediately”, “snow expected to transition to ice rain in 22 minutes” or any other notification format that may be relevant to a user.

In an illustrative example of a weather prediction system, some disclosed embodiments of the weather prediction system may involve receiving sensor data generated by a sensor system measuring weather related data that characterizes an environment in a vicinity of the sensor system as of a current time point, wherein the sensor data comprises a plurality of sensor samples characterizing the environment that were each captured at different time points. A “sensor system” may include, but is not limited to, one or more ground based sensors, including thermometers, barometers, anemometers, hygrometers, rain gauges, pyranometers, ceilometers and other weather sensors collecting environmental data, remote sensors, including weather radars, satellites, lidar sensors, sounding sensors and any other type of measurement device detecting weather related phenomenon, oceanic and specialized sensors, including buoys, drifters, tide measurements and flux towers and advanced sensors for machine learning applications, including spectroradiometers, multispectral and hyperspectral sensors and GNSS radio occultation sensors.

By way of an example, a thermometer or temperature sensor may provide a temperature measurement of the environment where it is installed. The thermometer may be designed in a housing to make a measurement of temperature along with electronics, that may also be included within the housing, to transmit the temperature measurement to a bridge and/or to a server via the cloud. In another example, a hygrometer or humidity sensor may provide a humidity measurement. A humidity sensor device may measure relative humidity in the air and transmit the measurement to a bridge and/or to a server via the cloud. A barometric pressure sensor may measure atmospheric pressure, and the measurement may be transmitted to a bridge and/or a server via the cloud. It is to be appreciated that sampling temperature, humidity and atmospheric pressure to provide a plurality of samples measurements over time that may allow processing, for example as sensor data input by a neural network, to determine or detect a pattern that may allow for a future weather prediction.

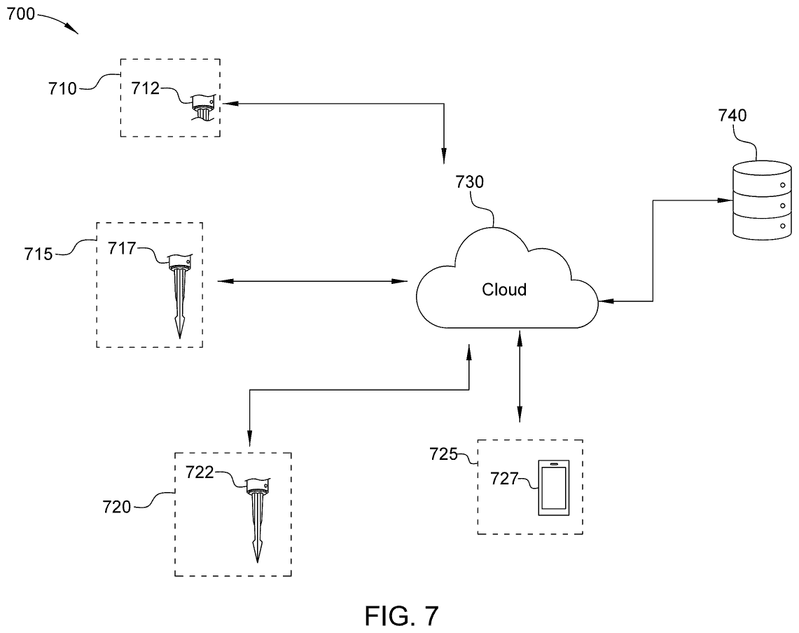

For example, as shown in FIG. 1, a wall weather sensor 110 and ground weather sensors 115 may include, but is not limited to, a temperature sensor, humidity sensor and a barometric pressure sensor. As shown in FIG. 7, a cloud connected weather prediction system 700 may include a wall weather sensor 712 at geographic location 710, a ground weather sensor 717 at geographic location 715 and a ground weather sensor 722 at geographic location 720. In the cloud connected weather prediction system 700, the weather sensors may connect directly to the cloud 730 to communicate to server 740. By way of an example, the connection may be a cellular data connection wherein the weather sensors may be installed at many disparate geographic locations.

Some disclosed embodiments may include one or more devices that comprise the sensor system that may include at least one of a temperature sensor, a humidity sensor, a barometric sensor or other type of ground-based weather or environmental sensor, remote sensor, oceanic or specialized sensor, advanced sensors for machine learning applications and any other type of device or sensor that may measure phenomenon related to weather or the environment.

Some disclosed embodiments may include sensor data provided by the sensor system. “Sensor data” may refer to the raw information or measurements collected by a device in the sensor system that may detect changes in an environment or specific conditions and may digitize or converts them into readable outputs. Sensors may measure various physical, chemical, or biological parameters, such as temperature, humidity, barometric pressure, wind speed, motion, light, sound, chemical composition or any other measurable phenomenon. Sensor data may be analog or digital, depending on the sensor type and application, and is often transmitted to other devices, systems, or networks for processing, analysis, or decision-making. This data may be crucial for monitoring systems, and Al applications, such as weather forecasting (e.g., weather prediction systems based on a neural network).

By way of an example, in FIG. 1 wall weather sensor 110 and ground weather sensors 115 may send sensor data via bridge 120 to server 140 via the cloud. As shown in FIG. 7, a cloud connected weather prediction system 700 wall weather sensor 712, ground weather sensor 717 and ground weather sensor 722 may send sensor data to server 740 via cloud 730. It is to be appreciated that sensor data may be packetized to send through a data network (e.g., the Internet) using any communication protocols that may be needed to communicate between two end points on a data network.

In some disclosed embodiments, the sensor data may comprise a plurality of sensor samples characterizing the environment that were each captured at different time points. For example, a weather sensor may measure an analog quantity and perform an analog to digital conversion at a plurality of time points (e.g., sample rate). The digitized sensor data may be packetized and transmitted via the data network to an end point. The digitized sensor data may be used to create a sensor data array for input to a neural network, for example as shown in FIG. 5 and described herein.

Some disclosed embodiments may include processing a sensor input comprising the sensor data using a neural network to generate a weather prediction output for a region of the environment. By way of an example, the sensor data may be arranged as a sensor input to pass into a neural network, such as shown in FIG. 3 and described herein. The sensor input may comprise of sensor measurements in a region of the environment. Thus, the neural network may generate a weather prediction output for the region of the environment. For example, a region of the environment may be a small town where a plurality of sensors may be installed. The sensor input may be comprised of sensor input from the plurality of sensor and therefore may allow for the neural network to generate a weather prediction output for the small town.

Consistent with some disclosed embodiments, the neural network may include at least one of a convolutional neural network, a recurrent neural network or a multi-layer perceptron neural network. For example, a neural network in the weather prediction system may be a convolutional neural network. Training of the convolution neural network based on a training data set of sensor inputs and a matching of actual weather data and weather prediction outputs may allow the convolutional neural network weights and parameters to be adjusted to provide an accurate weather prediction output.

In some disclosed embodiments, the weather prediction output characterizes, for one or more future intervals of time after the current time point, a respective likelihood that the region of the environment will be affected by a change in weather in the environment during the future interval of time. For example, the change in the weather may be predicted by the output of the neural network (e.g., the feature vector output by the neural network may be used to identify the change in weather in the environment during the future interval of time). The neural network may do this by identifying one or more patterns in the sensor input data that have a similarity to known future weather conditions. The feature vector output may identify one or more patterns and, as shown in FIG. 4 and described herein, allow a prediction of the future weather conditions. Thus, in some disclosed embodiments, the neural network may be used to process sensor input data and produce an output indicative of a prediction of a future weather condition.

Consistent with some disclosed embodiments, the neural network may be implemented in at least one of a local bridge and a server in the cloud. By way of an example, as shown in FIG. 6, the neural network may be implemented with processor 622 and memory 624 operating on the input from the sensor system 610. In some embodiments, the neural network may be implemented in software running on the bridge 120 operating on input from a local sensor system 610. In other embodiments, the neural network may be implemented in software running on the server 140 or server 740 based on sensor data received from sensor system 610. It is to be appreciated that the sensors may be geographically remote from server 140 or server 740. Thus, in some disclosed embodiments, the sensor input may be received by the neural network via a system of sensors where the sensor data may be communicated through a network (e.g., cloud 130) to the processing device implementing the neural network.

In some disclosed embodiments the sensor input to the neural network may include an array of sensor data of an interval of time. Referring to FIG. 4 and FIG. 5, the array of sensor data of an interval of time may include samples from one or more intervals of time of a plurality of different sensor types. As shown in FIG. 4, a plurality of sensor data inputs, for example from sensor systems at disparate geographical location, may be provided to the trained neural network, producing a different weather prediction output for each of the disparate geographic locations.

In some disclosed embodiments, the output of the neural network may be the weather prediction output represented or indicated by a feature vector. As shown in FIG. 4, the feature vector may be used to identify clusters of similar sensor input patterns. Sensor input data may be input to the neural network, a feature vector may be the weather prediction output of the neural network and post processing of the feature vector may be used to determine the weather prediction. Based on historical data (e.g., known weather conditions for a set of sensor data), a prediction of future weather conditions may be made. Thus, consistent with some disclosed embodiments, the feature vector may relate to a cluster of similar feature vectors that provide the weather prediction.

Some disclosed embodiments may include providing a weather prediction based on the weather prediction output to an alert system to generate a notification of a future weather condition. As shown in FIG. 7, cellular phone 727 at geographic location 725 may be sent a notification of a future weather condition. For example, a tornado warning may be presented to the user of cellular phone 727 via a push notification or an emergency alert notification. Thus, consistent with some disclosed embodiments, the weather prediction may include the future weather condition. In some disclosed embodiments, the weather prediction based on the weather prediction output of a future weather condition is used to provide a notification to an alert system.

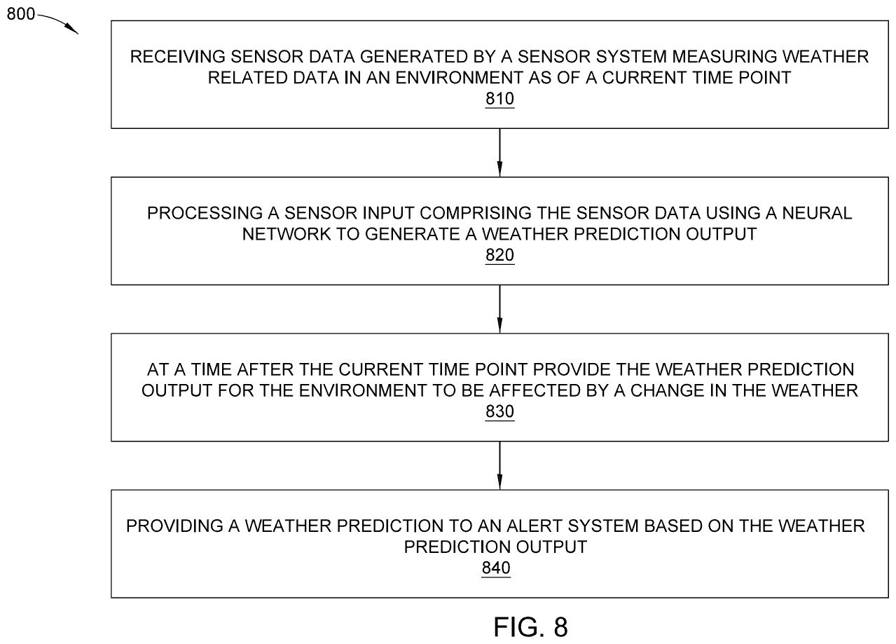

FIG. 8 is a flowchart showing exemplary process 800 for weather prediction system based on a neural network and weather sensor data. Processing unit 620, such as shown in FIG. 6 for example, may execute instructions to implement exemplary process 800. At step 810, processing unit 620 may receive sensor data generated by a sensor system measuring weather related data in an environment as of a current time point. At step 820, processing unit 620 may process a sensor input comprising the sensor data using a neural network to generate a weather prediction output. At step 830, processing unit 620 may provide, at a time after the current time point, the weather prediction output for the environment to be affected by a change in the weather. At step 840, processing unit 620 may provide a weather prediction to an alert system based on the weather prediction output.

In a second illustrative example of a cloud connected weather prediction system, including cloud server communication capability, some disclosed embodiments may include one or more weather sensors each including a sensor, a wireless transceiver, a processing device, and a housing; wherein at least one of the one or more weather sensors is configured to transmit, via the wireless transceiver, a signal indicative of a weather condition.

In some disclosed embodiments, a bridge device configured to be located separately from the one or more weather sensors, the bridge device including a first transceiver, a second wireless transceiver, a processor and a power source. In some disclosed embodiments, the one or more weather sensors may communicate directly to the cloud (i.e., there may not be a bridge in some systems).

In some disclosed embodiments, the bridge device may be configured to receive, via the second wireless transceiver, the signal indicative of a weather condition from the one or more weather sensors and transmit, via the first transceiver, a weather condition indication to a cloud server. In some disclosed embodiments, the bridge device may be configured to process a plurality of signals indicative of a weather condition to provide a prediction of a future weather condition.

Consistent with some disclosed embodiments, the cloud server may communicate to at least one of a cellular phone, a software application, or an alert system an alert indication based on the prediction of the future weather condition.

In some disclosed embodiments, the one or more weather sensors may include at least one of a temperature sensor, a humidity sensor or a barometric sensor. In some disclosed embodiments, the signal indicative of a weather condition provided by the one or more wireless sensors may include a least one of temperature, humidity, barometric pressure or wind speed.

Consistent with some disclosed embodiments, the neural network may be implemented by a server in the cloud. In some disclosed embodiments, the output of the neural network implemented in the server is the weather prediction output represented by a feature vector. In some disclosed embodiments, the feature vector relates to a cluster of similar feature vectors that provide the weather prediction. In some disclosed embodiments, the prediction of the future weather condition includes a prediction of at least one of rain, snow, temperature, humidity or wind speed at a future period of time.

In some disclosed embodiments, the software application is at least one of a cell phone application for weather or a news website providing weather forecasts. In some disclosed embodiments, the alert system is at least one of a tornado early warning system or a severe weather notification service.

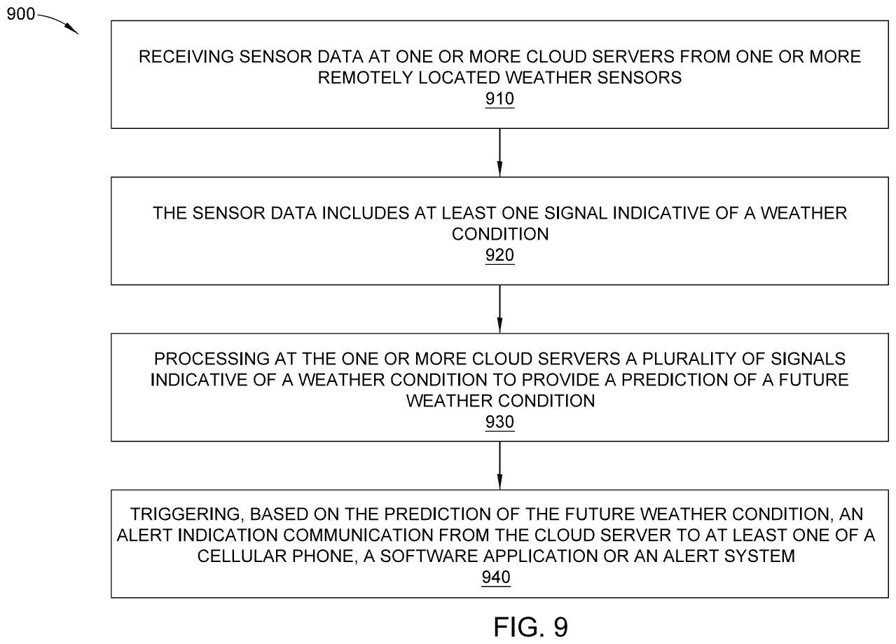

FIG. 9 is a flowchart showing exemplary process 900 for a cloud connected weather prediction system. Processing unit 620, such as shown in FIG. 6 for example, may execute instructions to implement exemplary process 900. At step 910, processing unit 620 may receive sensor data at one or more cloud servers from one or more remotely located weather sensors. At step 920, processing unit 620 may process sensor data that may include at least one signal indicative of a weather condition. At step 930, processing unit 620 may process at the one or more cloud servers a plurality of signals indicative of a weather condition to provide a prediction of a future weather condition. At step 940, processing unit 620 may trigger, based on the prediction of the future weather condition, an alert indication communication from the cloud server to at least one of a cellular phone, a software application of an alert system.

In an exemplary disclosed embodiment, a neural network may be implemented in a weather sensor device. By way of an example, a weather sensor device (e.g., weather station) with a plurality of weather and environmental sensors and a display screen may be implemented in a system similar to that shown FIG. 6. The processor 622 may collect sensor data from sensor system 610 and build an array of sensor data, similar to shown in FIG. 5 (e.g., sensor array data structure over time 500). The weather sensor device may monitor the environment around the home of a consumer (e.g., weather conditions in the back yard) with an array of sensors measuring wind speed, wind direction, temperature, humidity, rainfall, UV intensity, solar radiation and any other sensors that may be designed into a home installed weather sensor device.

In some embodiments, the neural network may be pre-trained and built into the weather sensor device. In some embodiments, the weather sensor device may receive or retrieve sensor data from a collection of weather data available from the national weather service, weather underground, national center for environmental information (NOAA) and other similar services that may provide real-time or historical weather sensor data and associated weather conditions. In some embodiments, the neural network may be trained off-line using an application in a server in the cloud and the weights and parameters from training may be loaded into the weather sensor device as an update. It is to be appreciated that the training may be based on sensor data collected over time associated with actual weather outcomes.

In some embodiments, more than one neural network may be implemented in the weather sensor device. By way of an example, different neural networks based on time-to-predicted weather conditions may be implemented where the sensor array of data at any time point may be input into a neural network providing a prediction in 1 minute, a second neural network providing a prediction in 5 minutes, a third neural network providing a prediction in 10 minutes and so on. It is to be appreciated that a weather sensor device may contain one or more neural networks trained to make weather predictions one or more future time points. In some embodiments, the display may show alerts or predictions of future weather conditions. In some embodiments, the weather sensor device may have a Bluetooth interface and an application running on a cell phone may allow a user to connect to the weather sensor device to receive alerts, view weather conditions or weather predictions and configure the weather sensor device for desired operation. In some embodiments, the weather sensor device may be self-training. For example, the weather sensor device may have an algorithm to capture sensor data, identify weather condition outcomes based on the captured data then implement the algorithm to automatically update the weights and parameters of the one or more neural networks.

In another exemplary embodiment, the weather sensor device (e.g., weather station) may operate as a bridge, as described herein, and one or more neural networks may be implemented in the bridge device. In such an embodiment, the weather sensor device may have weather sensors designed into the weather sensor device and/or remote weather sensors that may communicate sensor data to the weather sensor device. By way of an example, a plurality of remote weather sensors may communicate via RF communication (i.e., via an RF transmitter or RF transceiver in the remote weather sensor) with the weather sensor device. The weather sensor device may be designed with an RF receiver or RF transceiver and thus may receive remote weather sensor data. By way of an example, the weather sensor device may be installed indoors and a plurality of remote weather sensors may be installed outdoors. The processor in the weather sensor device may assemble an array of sensor data to input into one or more neural networks in the weather sensor device (i.e., bridge). Further, the weather sensor device may have a second communication interface to allow it to communicate with a server in the cloud. The weather sensor device may provide sensor data to the server and may receive training updates from the server. In some embodiments, the weather sensor device may have the capability to be trained directly and in other embodiments, the weather sensor device may receive training updates from the server.

In another exemplary embodiment, a weather prediction system may be developed wherein one or more neural networks may be implemented in a server. In some embodiments, a sensor system may include privately owned weather stations. For example, a plurality of weather stations installed in a plurality of consumer homes and backyards may measure and/or monitor weather conditions with an array of sensors measuring wind speed, wind direction, temperature, humidity, rainfall, UV intensity, solar radiation and any other sensors that may be designed into a home installed weather station. In some embodiments, the weather station may be connected to the network via Wifi or Ethernet and have a connection to the cloud through the home network. Sensor data collected at disparate locations may be uploaded to the server in real-time or in near real-time. The server may implement a system similar to that shown in FIG. 6 wherein processor 622 may assemble a plurality of arrays of sensor data from a plurality of geographic locations to input to one or more neural networks associated with the geographic locations. Thus, a server may make a plurality of weather predictions for a plurality of geographic locations. In some embodiments, a specialized weather station may be designed with a plurality of sensors with communications compatibility to operate properly with the server implementing one or more neural networks as described here. In some embodiments, the server may receive or retrieve sensor data from a collection of weather data available from the weather national weather service, weather underground, national center for environmental information (NOAA) and other similar services that may provide real-time or historical weather sensor data and associated weather conditions. As such, the server may use a mix of sensor data collected via sensor systems at geographic locations and data available from a plurality of weather data services, combining the data in an array of sensor data that may allow one or more trained neural networks to make the most optimal weather prediction of future weather conditions possible. In some embodiments, the server may communicate via a network to send alerts, notification or updates regarding changes in weather conditions to the cellular phone, computer or other user end device.

The described embodiments and examples relate to weather prediction however the approach may be applied to other applications. Some example applications include security systems, industrial sensor networks, Internet of Things (IoT) devices and systems and sensor networks of various types. A neural network may be employed in a security system to enhance various aspects of security, including intrusion detection, access control, surveillance, and threat recognition by training the neural network on security sensor data over time patterns to identify security events. In one example, a neural networks may be trained to detect anomalies or unusual patterns in security sensor data over time, making them effective for intrusion detection systems. A neural network may learn normal entry behavior and raise alerts when identified entry behavior deviations may be indicative of potential security threats (e.g., an intrusion). Thus, using IoT devices and a neural network, predictions about occupancy may be made in an office building.

A neural network may be integrated into IoT systems to enhance functionality, intelligence, and decision-making capabilities. For example, a neural network may analyze data from IoT sensors over a time series to predict equipment failures or maintenance needs. By identifying patterns indicative of impending issues, the system may schedule maintenance tasks proactively, minimizing downtime. In healthcare IoT applications, a neural network may analyze sensor data over time from wearables or medical devices to monitor patient health. The system may predict potential health issues based on patterns in the data, allowing for timely intervention. In smart home applications, a neural network may analyze sensor data over time to learn patterns of user behavior. This may enable the automation of home settings based on individual preferences and may anticipate user needs. As an extension of the weather and environmental sensor described herein, sensors collecting weather and environmental data may benefit from a neural network analyzing patterns in air quality, temperature, and other parameters. This information may be used for pollution detection, climate modeling, and resource management. It is to be appreciated that embodiments and examples described herein, with alternate sensors and alternate training of a neural network based on the specified application, may be used in the other applications.

The present disclosure provides advantages. For example, improvements are described for procedures and systems related to improved prediction of future weather conditions and events are disclosed above.

What is claimed is:

1. A method implemented by one or more data processing apparatus, the method comprising:
receiving sensor data generated by a sensor system measuring weather related data that characterizes an environment of the sensor system as of a current time point, wherein the sensor data comprises a plurality of sensor samples characterizing the environment that were each captured at different time points;
processing a sensor input comprising the sensor data using a neural network to generate a weather prediction output for a region of the environment, wherein:
the weather prediction output characterizes, for one or more future intervals of time after the current time point, a respective likelihood that the region of the environment will be affected by a change in weather in the environment during the future interval of time; and
providing a weather prediction based on the weather prediction output of a future weather condition.

2. The method of claim 1 wherein the sensor system includes at least one of a temperature sensor, a humidity sensor and a barometric sensor.

3. The method of claim 1, wherein the sensor data provided by the sensor system may include a least one of temperature, humidity, barometric pressure and wind speed.

4. The method of claim 1, wherein the neural network is at least one of a convolutional neural network, a recurrent neural network or a multi-layer perceptron neural network.

5. The method of claim 4, wherein the neural network is implemented in at least one of a local bridge and a server in the cloud.

6. The method of claim 1, wherein the sensor input is received by the neural network.

7. The method of claim 6, wherein the sensor input received by the neural network is an array of sensor data of an interval of time.

8. The method of claim 1 wherein the output of the neural network is the weather prediction output represented by a feature vector.

9. The method of claim 7, wherein the feature vector relates to a cluster of similar feature vectors that provide the weather prediction.

10. The method of claim 1, wherein the weather prediction is the future weather condition.

11. The method of claim 10, wherein the weather prediction based on the weather prediction output of the future weather condition is used to provide a notification to an alert system.

12. A system comprising:
one or more computers; and
one or more storage devices communicatively coupled to the one or more computers, wherein the one or more storage devices store instructions that, when executed by the one or more computers, cause the one or more computers to perform operations comprising:
receiving sensor data generated by a sensor system measuring weather related data that characterizes an environment of the sensor system as of a current time point, wherein the sensor data comprises a plurality of sensor samples characterizing the environment that were each captured at different time points;
processing a sensor input comprising the sensor data using a neural network to generate a weather prediction output for a region of the environment, wherein:
the weather prediction output characterizes, for one or more future intervals of time after the current time point, a respective likelihood that the region of the environment will be affected by a change in weather in the environment during the future interval of time; and
providing a weather prediction based on the weather prediction output to an alert system to generate a notification of a future weather condition.

13. One or more non-transitory computer storage media storing instructions that when executed by one or more computers cause the one or more computers to perform operations comprising:
receiving sensor data generated by a sensor system measuring weather related data that characterizes an environment of the sensor system as of a current time point, wherein the sensor data comprises a plurality of sensor samples characterizing the environment that were each captured at different time points;
processing a sensor input comprising the sensor data using a neural network to generate a weather prediction output for a region of the environment, wherein:
the weather prediction output characterizes, for one or more future intervals of time after the current time point, a respective likelihood that the region of the environment will be affected by a change in weather in the environment during the future interval of time; and
providing a weather prediction based on the weather prediction output to an alert system to generate a notification of a future weather condition.
